(19) United States
(12) Patent Application Publication
(10) Pub. No.: US 2006/0013003 A1
(43) Pub. Date: Jan. 19, 2006

(54) High illumination light emitting diode

(75) Inventors: Ming-Shun Lee, Taipei (TW); Ping-Ru Sung, Taipei (TW)

Correspondence Address: TROXELL LAW OFFICE PLLC, 5205 LEESBURG PIKE, SUITE 1404, FALLS CHURCH, VA, 22041, US

(73) Assignee: Taiwan Oasis Technology Co., Ltd.

(21) Appl. No.: 10/879,171

(22) Filed: Jun. 30, 2004

(51) Int. Cl. F21V 7/00

(52) U.S. Cl. 362/341

(57) ABSTRACT

A high illumination light emitting diode includes a transparent insulator containing conducting ends of different polarities and a carrier; a chip being fixed to the carrier, fluorescent material being applied to the peripheral of the chip; a gold plated wire connecting the electrode and those conducting ends; a reflector being fixed to the carrier on the side attached with the chip; and the light emitted from the chip being projected toward the exterior of the transparent insulator due to the reflection of the reflector to effectively increase the illumination of the light emitting diode.

### BACKGROUND OF THE INVENTION

(a) Field of the Invention

The present invention is related to an art of upgrading the illumination of a light emitting diode for providing a construction of the light emitting diode with the effects of high illumination performance.

(b) Description of the Prior Art:

Light emitting diode characterized by smaller size, lower power consumption, lower heat and longer service life has been gradually replaced the conventional tungsten lamp bulb of similar functions applied in Christmas decorative string lamps, signal lights on vehicles, traffic signs and other commodities. The light emitting diode is essentially comprised of a transparent insulator containing multiple conducting ends of different polarities and a carrier, a chip is fixed to the carrier, fluorescent material is applied to the peripheral of the chip, a gold plated wire connects the electrode of the chip and those conducting ends, and each conducting end extends through the transparent insulator to become a power source contact. When the conducting ends are conducted, the light generated from the chip emits through the fluorescent material and to become the visible light as expected by incorporating the wavelength of the fluorescent material. Therefore, given with the improved manufacturing process and technology, the light emitting diode may become a light-emitting device with performance of specific light color through the design of the fluorescent material to fast expand the application range of the light emitting diode.

However, the existing R&D efforts on the light emitting diode focuses on the effects of the light color performance and promotion of the production capacity. Less attention is paid on how to increase the illumination of the light emitting diode.

### SUMMARY OF THE INVENTION

The primary purpose of the present invention is to provide a high illumination light emitting diode to increase the illumination of the light emitting diode. To achieve the purpose, the light emitting diode includes a transparent insulator containing multiple conducting ends of different polarities, and a carrier; a chip is fixed to the carrier and fluorescent material is applied to the peripheral of the chip; and a gold plated wire connect the electrode of the chip and those conducting ends. A reflector provided to the carrier on the side attached with the chip project the light source of the chip towards the exterior of the transparent insulator to effectively increase the illumination of the light emitting diode.

The type of the fluorescent material may vary depending on the spatial configuration and manufacturing process of the light emitting diode; and the reflector may be present in the form of mirror layer, glass mirror, metal plated layer, or baking varnished metal.

### BRIEF DESCRIPTION OF THE DRAWINGS

FIG. 1 is a schematic view showing the construction of a first preferred embodiment of the present invention.

FIG. 2 is an exploded view showing the relative adaptation among a chip, a mirror layer, and conducting end of the present invention.

FIG. 3 is a schematic view showing a construction of a second preferred embodiment of the present invention.

FIG. 4 is a schematic view showing a construction of a third preferred embodiment of the present invention.

### DETAILED DESCRIPTION OF THE PREFERRED EMBODIMENTS

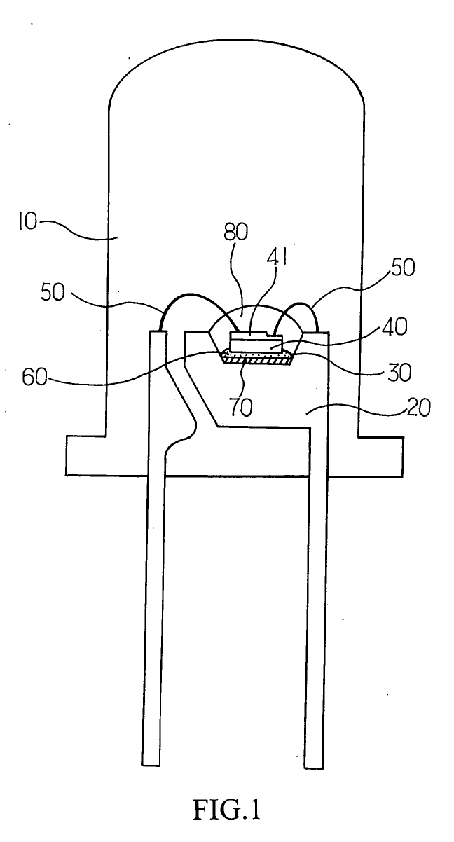

Referring to FIG. 1 for the basic configuration of a light emitting diode of a first preferred embodiment of the present invention, a transparent insulator 10 contains multiple conducting ends 20 of different polarities and a carrier 30; a chip 40 is fixed to the carrier and a fluorescent material 60 is applied to the peripheral of the chip 40; a gold plated wire 50 connects an electrode 41 of the chip and those conducting ends 20; and each conducting end 20 extends through the transparent insulator 10 to become a power source contact. Accordingly, when the conducting ends 20 are conducted, the light emitted from the chip 40 has its wavelength incorporated with that from the fluorescence 60 as it passes through it to become visible light as expected.

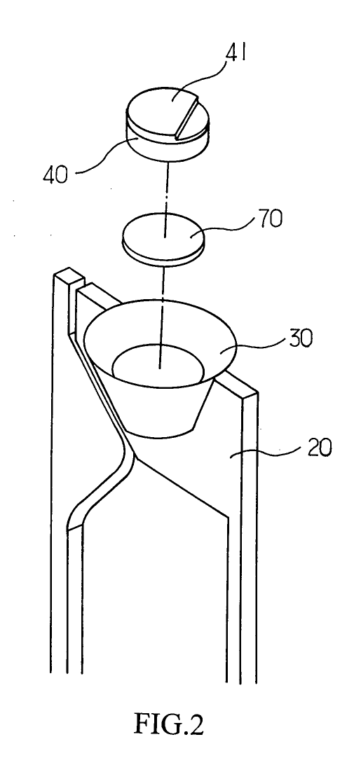

As illustrated in FIG. 2, a reflector 70 is further fixed to the carrier 30 on the side adapted with the chip 40. The carrier 30 is made in a bowl shape provided on one of those conducting end 20, and the reflector 70 relates to a glass mirror adhered at where between the chip and the bottom of the carrier 30. The fluorescent material 60 comprised of admixture of the adhesive material that bonds the chip 40 and the fluorescent material is adapted at where between the chip 40 and the reflector 70 so to adhere the chip 40 to the upper part of the reflector. The light emitted from the light source of the chip 40 is reflected by the reflector to project to the exterior of the transparent insulator 10 to effectively increase the illumination of the light emitting diode.

Furthermore, the type of the fluorescent material may vary depending on the spatial configuration and manufacturing process of the light emitting diode; and the reflector may be present in the form of mirror layer, glass mirror, metal plated layer, or baking varnished metal.

The light emitting diode of the first preferred embodiment of the present invention as illustrated in FIG. 1 is completed with two times of baking during the manufacturing process. Wherein, the chip 40, the reflector 70 and the carrier are combined in the baking process; the surface of the chip 40 is coated with a course of transparent glue 80 while having the gold plated wire 50 to connect the electrode 41 and those conducting ends before the diode is put into the baking process once again. The finished diode has the transparent insulation glue 80 formed on the surface of the chip 40.

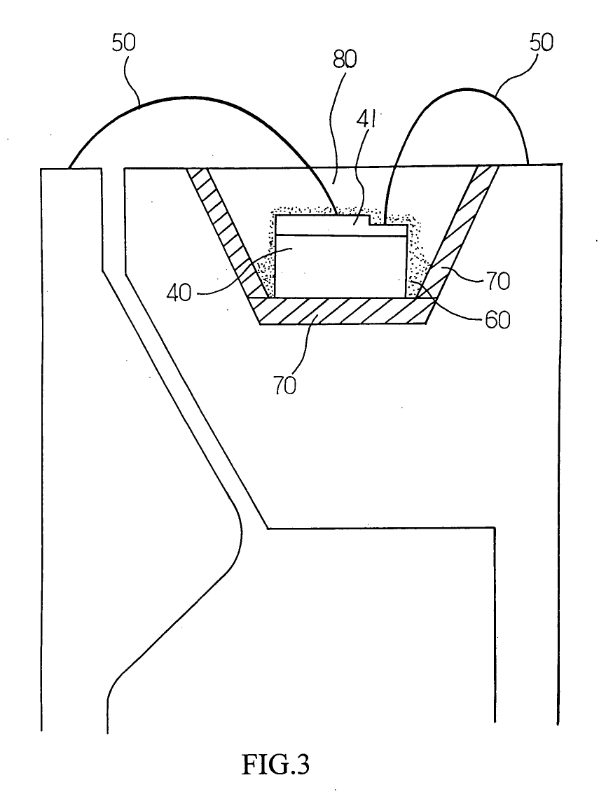

A construction of the diode of a second preferred embodiment of the present invention is completed with a single baking process as illustrated in FIG. 3. Wherein, reflector 70 all over the inside are of the bowl carrier 30; the chip 40 is directly placed on the reflector 70; the gold plated wire 50 connects the electrode 41 of the chip 40 and those conducting ends 20; and the carrier 30 is filled up with the fluorescent material 60 comprised of the transparent insulation glue and fluorescent powder. Finally, the diode is hardened in the second baking process. During the baking process, the fluorescent powder consistently covered up on the surface of the chip due to the central gravity and the transparent glue in the entire fluorescent material 60 turns into a clear light permeable construction.

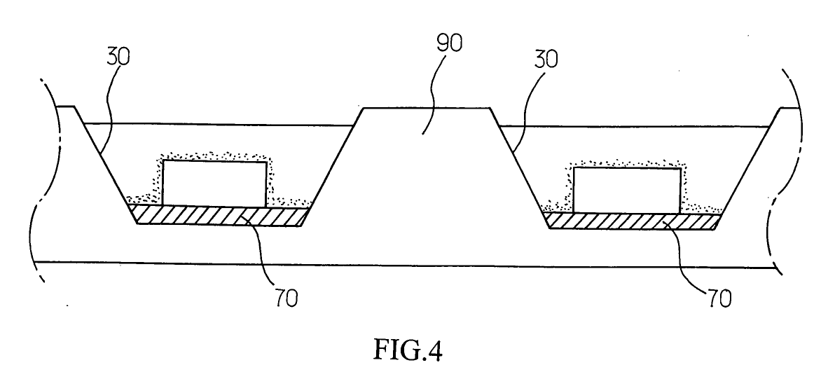

A third preferred embodiment of the present invention as illustrated in FIG. 4 has the diode directly provided on a circuit board 90. Multiple pits are preset on the circuit board 90 to each define the carrier 30; the reflector is fixed on the bottom inside the carrier 30; and each conducting end (not illustrated) is directly arranged on the circuit contact of the circuit board 90.

The present invention provides the art to effectively increase the illumination of the light emitting diode and this application for a patent is duly filed accordingly. However, that it is to be noted that the preferred embodiments and the accompanying drawings disclosed in the specification do not in any way restrict the present invention and that any structure, device and characteristics that are similar, or identical with those of the present invention shall be deemed as falling within the objective and the claims of the present invention.

I Claim:

1. A high illumination light emitting diode includes a transparent insulator containing conducting ends of different polarities and a carrier; a chip being fixed to the carrier, fluorescent material being applied to the peripheral of the chip; a gold plated wire connecting the electrode and those conducting ends; a reflector being fixed to the carrier on the side attached with the chip; and the light emitted from the chip being projected toward the outer of the transparent insulator due to the reflection of the reflector to effectively promote the illumination of the light emitting diode.

2. A high illumination light emitting diode as claimed in claim 1, wherein, the reflector relates to a layer of mirror.

3. A high illumination light emitting diode as claimed in claim 1, wherein, the reflector relates to a glass pane.

4. A high illumination light emitting diode as claimed in claim 1, wherein, the reflector relates to a glass mirror adhered to the carrier.

5. A high illumination light emitting diode as claimed in claim 1, wherein, the reflector relates to a metal plated layer.

6. A high illumination light emitting diode as claimed in claim 1, wherein, the reflector relates to a baking varnished metal.

7. A high illumination light emitting diode as claimed in claim 1, wherein, the carrier is made in a bowl shape.

8. A high illumination light emitting diode as claimed in claim 1, wherein, the carrier is provided on one of those conducting ends.

9. A high illumination light emitting diode as claimed in claim 1, wherein, each conducting end relates to a circuit contact provided on the circuit board.

10. A high illumination light emitting diode as claimed in claim 1, wherein, each conducting end relates to a circuit contact provided on the circuit board and the carrier relates to the pit preset on the circuit board.

11. A high illumination light emitting diode as claimed in claim 1, wherein, the fluorescent material relates to an admixture of transparent insulation glue and fluorescent powder.

12. A high illumination light emitting diode as claimed in claim 1, wherein, the fluorescent material is related to an admixture of fluorescent powder and the adhesive material that bonds the chip to the carrier.

13. A high illumination light emitting diode as claimed in claim 1, wherein, the surface of the chip is covered up with transparent insulation glue.

14. A high illumination light emitting diode as claimed in claim 1, wherein, the fluorescent material is applied at the bottom of the chip.

15. A high illumination light emitting diode as claimed in claim 6, wherein, the reflector is provided on the inner side in relation to the bowl.
